(19) United States
(12) Patent Application Publication
(10) Pub. No.: US 2023/0383825 A1
(43) Pub. Date: Nov. 30, 2023

(54) BALL SCREW DRIVE

(71) Applicant: SFS Group International AG, Heerbrugg/St. Gallen (CH)

(72) Inventors: Marijo Zach, Widnau (CH); Daniel Sinz, Kennelbach (AT); Jasmin Hanselmann, Altstätten (CH); Ralph Sieber, Diepoldsau (CH)

(73) Assignee: SFS Group International AG, Heerbrugg/St. Gallen (CH)

(21) Appl. No.: 18/322,729

(22) Filed: May 24, 2023

(30) Foreign Application Priority Data
May 24, 2022 (EP) 22175185.2

(51) Int. Cl. F16H 25/22

(52) U.S. Cl. CPC F16H 25/2214

(57) ABSTRACT

A ball screw drive includes a threaded spindle and a spindle nut with a plurality of balls that circulate endlessly in the intermediate space between the nut and the spindle. A ball return guide guides balls at one location out of the helical ball race by a ball deflector and feeds the balls back via a transition channel and another ball deflector. The ball deflectors are arranged in radial through-openings in the lateral surface of the nut. One or more small metal plates are provided on the nut, and are arranged in and/or adjacent to the radial through-openings and offset inwardly away from the lateral surface, and span the ball return guide in a planar manner. The ball return guide is fixed in a target position in the lateral surface of the nut, and when fully assembled the small metal plates do not protrude beyond the lateral surface.

### CROSS-REFERENCE TO RELATED APPLICATIONS

This application claims priority to European Patent Application No. 22175185.2, filed May 24, 2023, which is incorporated herein by reference as if fully set forth.

### TECHNICAL FIELD

The present invention relates to a ball screw drive, in particular to the improved and simplified construction of the ball deflector of a ball screw drive.

### BACKGROUND

Nowadays ball screw drives play an increasing role in electromechanical and electrohydraulic brake systems, where ball screw drives are used as a replacement for hydraulic brake cylinders or in parallel with known brake systems in brake assistance systems.

Generally, a cylindrical screw drive with balls as the rolling bodies is denoted as a ball screw drive. The main constituent parts of a ball screw drive include a threaded spindle and a spindle nut which encompasses this spindle. During operation, balls circulate between these two components. The thread flights of the threaded spindle and the spindle nut are configured as ball grooves with a suitable profile and are adapted to one another in a complementary manner such that together (in the assembled state) they form a ball race or ball guide. In contrast to a screw-nut connection, in which the thread flanks slide on one another in a planar manner, in the ball screw drive the circulating balls in the thread take over the transmission of the load between the nut and spindle. The planar sliding movement is thus replaced by a rolling (off) movement which is associated with reduced friction.

Ball return guides are used in order to obtain a closed circulation path for the balls. These ball return guides are functionally (frequently also structurally) composed of two ball deflectors and a transition channel located therebetween. The ball deflectors have the task of lifting out the balls from the ball guide at a first location between the spindle nut and the threaded spindle and feeding the balls back at a second location. A ball return guide thus represents as a whole a bypass which bridges one or more thread flights of the nut-spindle system and thus forms a closed circulation path for the balls of a ball screw drive. Generally, the balls in the spindle nut are lifted radially outwardly from the ball groove and guided inside or outside the spindle nut in a channel or a tube (the transition channel) before they are re-inserted at the location provided therefor in the ball race between the threaded spindle and the spindle nut. The forces which are released when the balls are lifted out from the ball guide have to be absorbed or diverted by the ball deflector. Thus the fastening or securing of the ball deflectors in/on the spindle nut is a technical challenge.

### PRIOR ART

A ball deflector which is designed in one piece is described in the prior art EP 3 809 013 A1, the ball deflector having an oval basic shape and thus being able to be inserted into a correspondingly shaped opening in the wall of a spindle nut. The ball deflector is designed such that it can be used both for lifting out and for re-introducing the balls into the ball race. These ball deflectors are generally fixed by a sleeve which is pushed over the spindle nut and which secures the position of the ball deflectors.

A ball return guide which is produced from two half shells is described in the prior art EP 1 375 966 A2, the ball return guide combining the ball deflectors and the transition channel. In one variant, it is described therein that a cylindrical sleeve is also used for the fixing. Moreover, a spring element which fixes the ball return guide in the target position is arranged therein between the ball return guide and the sleeve.

As an alternative to securing by means of a sleeve, it is known to provide on the ball return guide snap-on devices and/or latching devices which engage in corresponding openings of the spindle nut. Thus, additional mechanical securing devices can generally be dispensed with.

These fixing devices according to the prior art have certain drawbacks in each case: while sleeves which have been pushed on are advantageous in terms of manufacture and assembly they do not permit the ball screw drive to be fastened in the region of the sleeve. Latching tongues and snap-on devices have to be designed to be sufficiently robust that they can withstand the forces which the balls exert on the ball deflector. Additionally, the production tolerances of the ball deflectors and the corresponding retaining openings in the spindle nut have to be sufficiently accurate that the function of the ball return guide is always ensured.

### SUMMARY

The object of the present invention is thus to propose a securing mechanism for a ball deflector which avoids the drawbacks and is also safe and simple to use.

A ball screw drive of the aforementioned type comprises in its essential features a threaded spindle and a spindle nut. This spindle nut at least partially coaxially encloses the threaded spindle in the manner of a hollow cylindrical sleeve. As a result, the spindle nut has a substantially cylindrical (radially external) lateral surface. Local deviations from the cylindrical shape, for example in the form of retaining elements, flattened portions, angled flanges, might be encompassed by the term “substantially cylindrical”. It should be mentioned that a cylindrical/sleeve-shaped external surface is the preferred embodiment; however, the invention is also able to be used in an equivalent manner on polygonal lateral surfaces.

A plurality of balls circulate in the intermediate space between the threaded spindle and the spindle nut in a helical ball race. At least one ball return guide with two ball deflectors and a transition channel running therebetween is required in order to achieve at least one endless ball track. In principle, it is possible to bridge one or more windings of the helical ball track between the threaded spindle and the spindle nut. The transition channel is thus also denoted as a ball return guide.

The ball deflectors are arranged as structural elements in radial through-openings in the spindle nut, such that-depending on the direction of rotation of the ball screw drive-the balls are radially lifted out of the ball race by the one ball deflector and are deflected into the transition channel. After passing through the transition channel, the balls are guided by the other ball deflector out of the transition channel back into the ball race. When the direction of rotation is changed, the ball deflectors (functionally) change roles.

According to the invention, one or more small metal plates are provided on the spindle nut, the small metal plates being arranged in and/or adjacent to the radial through-openings and being offset inwardly away from the lateral surface, and at least partially spanning the ball return guide in an planar manner. “In and/or adjacent to the radial through-openings” is understood to mean that a small plate can entirely or partially span a through-opening but can also be anchored down in the surfaces adjacent to the through-openings, where this is technically required or expedient.

As a result, the ball return guide is fixed with its ball deflectors in a target position in the lateral surface of the spindle nut. When they are fully assembled, the small metal plates do not protrude beyond the lateral surface of the spindle nut.

The fastening of the small metal plates in or adjacent to the through-openings of the spindle nut is carried out by spot welding, adhesive bonding or clamping.

The advantage of this design according to the invention is that the ball return guide does not interfere with the external contour of the ball screw drive, which facilitates the fastening of the ball screw drive via the spindle nut.

The transition channel is described here in two principal variants; a person skilled in the art, however, can also transfer the aforementioned inventive features on a case-by-case basis to other concepts or designs. The transition channel can be designed firstly as a longitudinally pressed-in, radially outwardly open channel in the spindle nut, for example by cold forming during the manufacture of the spindle nut. In the second variant, the transition channel can be designed as a longitudinal bore in the lateral surface of the spindle nut parallel to the axis of rotation of the spindle nut. The through-openings for the ball deflectors are thus machined out of the lateral surface of the spindle nut, for example by milling, in order to define a portion of the longitudinal bore or the pressed channel as a transition channel.

In one embodiment, the ball return guide for a ball screw drive which is described herein can be implemented in one piece with two ball deflectors and a tubular transition channel arranged therebetween (axially parallel longitudinal bore in the lateral surface of the spindle nut).

A ball return guide can also be assembled from individual pieces, which for example are made of plastics and/or metal, and arranged in a groove. This groove is introduced into the lateral surface and adapted to the shape of the ball return guide or optimized therefor. The individual pieces can follow, for example, the principle of a “covered groove” or “tubular transition channel with added end pieces”. The latter is also functionally present when the ball return guide is constructed from two ball deflectors which are designed in one piece and which are separately inserted into radial through-openings and with a longitudinal bore located therebetween as a transition channel. Alternatively, the transition channel can also be arranged as a discrete component in a trough-shaped channel.

The above-described small metal plates which secure the ball return guide or the parts thereof will not protrude beyond the casing surface or lateral surface of the actual spindle nut in the fully installed state. The following variants are possible here: in their fully assembled position the small metal plates terminate flush with the lateral surface of the spindle nut and thus complete the lateral surface relative to the original initial shape. Alternatively, in their fully assembled position the small metal plates can be arranged to be at least partially countersunk in the lateral surface of the spindle nut. Mixed forms (flush/countersunk) are technically not excluded. The option which is selected essentially depends on the geometric and structural design of the spindle nut.

In a further embodiment of a ball screw drive, the small metal plates can ensure the fixing of the ball deflectors or the ball return guide by a resilient pressing contact. Additionally, a damping and/or resilient intermediate layer can be provided between the small metal plates and the ball return guide or the ball deflector(s). Such an intermediate layer, which is made of an elastic material, can assist with the compensation of production tolerances and will reduce the transmission of structure-borne noise from the ball return guide or ball deflector to the spindle nut.

The small metal plates discussed herein are preferably produced from spring steel and, in particular, are stamped out from spring steel sheet for the manufacture thereof. Depending on the requirement, the material thickness is 0.05 to 0.25 mm. Known types of steel having resilient properties are available commercially and called C75S (1.1248) or 1.4310 CrNi steel.

For specific applications, the small metal plates can be designed such that they have a bulge along one axis. As a result, during assembly the small metal plates can be oriented such that in the final assembled position the small metal plate(s) exerts or exert a continuous compressive force on a ball return guide or the ball deflector(s). The bulge can be implemented at the same time as the stamping out process, by embossing.

Depending on the application of the ball screw drive, it can be required or expedient that at least one small metal plate closes a radial through-opening over the entire surface. This can be necessary in order to reduce or avoid the ingress of dirt into the region of the circulating balls.

Alternatively, it can be sufficient if at least one small metal plate partially covers the radial through-opening, if this is sufficient for the function of securing the ball return guide.

Depending on the design of the ball screw drive, it is possible that at least one small metal plate entirely or partially covers a plurality of radial through-openings.

The embodiments and variants described herein can be combined in many different ways. Where technical alternatives have been described (for example a transition channel as a longitudinal bore or as a groove) the possibilities for a person skilled in the art for using and combining the variants described and shown can be clearly assigned on the basis of this description and the drawings.

The manufacture of a ball screw drive described herein can be described in a simplified manner as follows:
the provision of components of a ball return guide according to the above-described variant;
the provision of a pre-assembled sub-assembly consisting of at least one spindle nut and one threaded spindle, wherein the spindle nut has two radially inwardly positioned through-holes. The contour of the spindle nut is designed such that it can receive the deflectors. The through-holes are connected by a transition channel;
the insertion of the ball deflectors/ball return guide in the lateral surface of the spindle nut;
the introduction of a plurality of balls in the ball screw drive;
the positioning of a small metal plate in the region of a through-opening in the spindle nut;
the fastening of the small metal plate by means of laser welding, clamping, adhesive bonding;

### BRIEF DESCRIPTION OF THE DRAWINGS

FIG. 1 shows schematically in a partial section a ball screw drive in a first embodiment of the invention.

FIG. 2 shows a ball screw drive with the spindle nut omitted. This illustrates the circulation of the balls.

FIG. 3 shows a longitudinal section through a ball screw drive in a second embodiment.

FIG. 4 shows a plan view of a ball screw drive in a third embodiment.

FIG. 5 shows a fourth embodiment of the invention.

### DETAILED DESCRIPTION

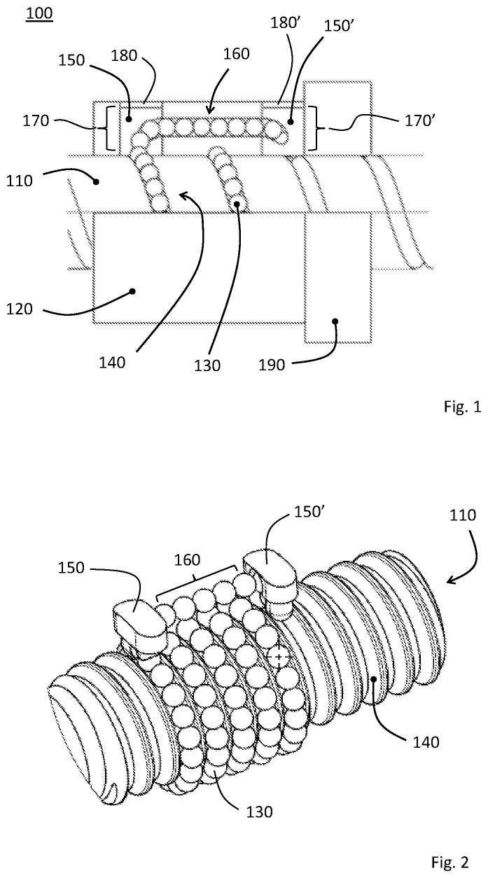

FIG. 1 shows a ball screw drive 100 in a partial section. The internal threaded spindle 110 comprises the internal half of the helical ball race 140 which cooperates with its corresponding counterpart, the channel designed as an internal thread of the spindle nut 120. The balls 130 circulate endlessly due to the ball return guide. The ball return guide in this case is made up of a first ball deflector 150, a transition channel 160 and a further ball deflector 150′. The ball deflectors 150, 150′ are countersunk in through-openings 170, 170′, which in turn are closed by small metal plates 180, 180′. The through-openings are bores or milled portions in the spindle nut 120, which extend radially from the inside to the outside and serve for receiving the ball deflectors. The ball deflectors are designed as tubular or groove-shaped structural elements such that they remove the load from the balls of the ball race 140 and divert the balls both radially outwardly and toward the transition channel. As already mentioned, there are many types of transition channel: as axially parallel grooves or bores in the spindle nut, as discrete components or as assembled elements made of metal and/or plastics.

The spindle nut is shown here as a substantially cylindrical body with a radially enlarged flange 190.

FIG. 2 shows by way of illustration the endless circulation of the balls in a ball screw drive with the spindle nut omitted. The balls 130 are guided in the spiral ball race 140. A ball deflector 150 removes the balls from the ball race, guides the balls into the transition channel 160 at which a further ball deflector 150′ feeds the balls 130 back into the ball race 140.

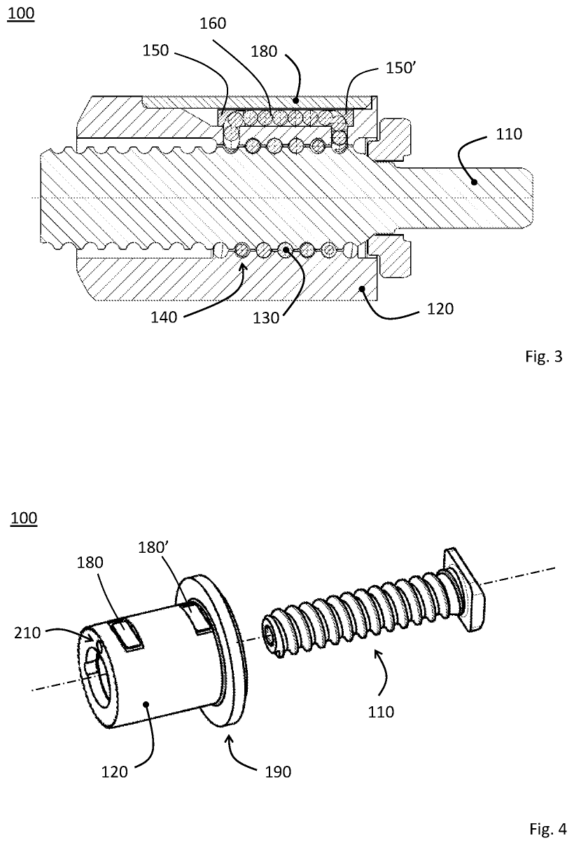

FIG. 3 shows a second embodiment of the invention in longitudinal section. The ball screw drive 100 consists once again of the threaded spindle 100 and the spindle nut 120 which form therebetween the helical ball race 140 with the balls 130 guided therein. The ball return guide is implemented in a recess in the spindle nut 120, which also encompasses the through-openings for the inserted ball deflectors 150, 150′. It can be identified that in this embodiment the small metal plate 180 forms the outwardly or upwardly closing top of the transition channel 160. The portion of the transition channel 160 shown horizontally in the figure is implemented as a milled-out groove.

FIG. 4 shows one implementation of a ball screw drive, wherein the threaded spindle 110 is shown separately. The transition channel is implemented as an axially parallel longitudinal bore 210. It is only possible to identify the small metal plates 180, 180′ which form the closure of the radial through-openings which receive the ball deflectors. It can be identified that these small metal plates do not protrude beyond the originally cylindrical external contour of the spindle nut.

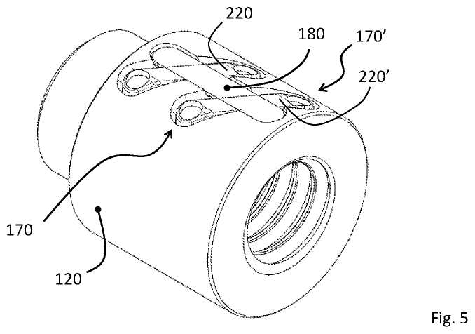

FIG. 5 shows a further variant of a spindle nut 120 without a threaded spindle in a perspective view with two ball deflectors 220, 220′. The through-openings 170, 170′ in each case form part of a groove in the threaded spindle 120 which comprises a one-piece ball return guide 220, 220′ which is to be inserted. A single small metal plate 180 secures the two ball deflectors in the manner of a bandage.

1. A ball screw drive, comprising:
a threaded spindle;
a spindle nut which at least partially coaxially encloses the threaded spindle, the spindle nut has a substantially cylindrical lateral surface;
a plurality of balls which circulate in an intermediate space between the threaded spindle and the spindle nut in a helical ball race;
a ball return guide with two ball deflectors and a transition channel running therebetween;
the ball deflectors are arranged in radial through-openings in the spindle nut such that, depending on a direction of rotation of the ball screw drive, the balls are radially lifted out of the ball race by one of the ball deflectors and are deflected into the transition channel, and after passing through the transition channel are guided by an other of the ball deflectors out of the transition channel back into the ball race;
one or more metal plates on the spindle nut, the metal plates being arranged at least one of in or adjacent to the radial through-openings and being offset inwardly away from the lateral surface, and spanning the ball return guide in a planar manner to fix the ball return guide with the ball deflectors in a target position in the lateral surface of the spindle nut, and upon being fully assembled, the metal plates do not protrude beyond the lateral surface of the spindle nut.

2. The ball screw drive as claimed in claim 1, wherein at least one of in or adjacent to the through-openings of the spindle nut, the one or more metal plates are spot welded, adhesively bonded or clamped to the spindle nut.

3. The ball screw drive as claimed in claim 1, wherein the transition channel is configured as a longitudinally pressed-in, radially outwardly open channel or as a longitudinal bore which is introduced into the lateral surface of the spindle nut parallel to an axis of rotation of the spindle nut.

4. The ball screw drive as claimed in claim 1, wherein the ball return guide comprises a single piece with the two ball deflectors and the tubular transition channel that forms the transition arranged therebetween.

5. The ball screw drive as claimed in claim 1, wherein the ball return guide comprises the two ball deflectors which are each formed in one piece and which are separately inserted into the radial through-openings and a longitudinal bore located in the spindle nut therebetween as the transition channel.

6. The ball screw drive as claimed in claim 1, wherein in in a fully assembled position, the one or more metal plates terminate flush with the lateral surface of the spindle nut.

7. The ball screw drive as claimed in claim 1, wherein in a fully assembled position, the one or more metal plates are arranged to be at least partially countersunk in the lateral surface of the spindle nut.

8. The ball screw drive as claimed in claim 1, wherein the one or more metal plates provide a resilient pressing contact to ensure the fixing of at least one of the ball deflectors or the ball return guide to the spindle nut.

9. The ball screw drive as claimed in claim 1, further comprising at least one of a damping or resilient intermediate layer between the one or more metal plates and the ball return guide or at least one of the ball deflectors.

10. The ball screw drive as claimed in claim 1, wherein the one or more metal plates are produced from spring steel.

11. The ball screw drive as claimed in claim 1, wherein the one or more metal plates have a bulge along one axis and during assembly are oriented such that in a final assembled position the one or more metal plate exerts a continuous compressive force on at least one of the ball return guide or the ball deflectors.

12. The ball screw drive as claimed in claim 1, wherein one of the at least one metal plate closes a radial through-opening over an entire surface.

13. The ball screw drive as claimed in claim 1, wherein the at least one metal plate partially covers the radial through-opening.

14. The ball screw drive as claimed in claim 1, wherein the at least one metal plate at least partially covers a plurality of radial through-openings.
